(19) United States
(12) Patent Application Publication
(10) Pub. No.: US 2026/0185572 A1
(43) Pub. Date: Jul. 2, 2026

(54) VEHICLE BRAKE SYSTEMS

(71) Applicant: HYUNDAI MOBIS CO., LTD., Seoul (KR)

(72) Inventors: Sang Pil BOO, Yongin-si (KR); Choong Sik SHIN, Yongin-si (KR); Se Hoon AN, Yongin-si (KR); Kang Kuk LEE, Yongin-si (KR); Sang Jun PARK, Yongin-si (KR)

(73) Assignee: HYUNDAI MOBIS CO., LTD., Seoul (KR)

(21) Appl. No.: 19/316,347

(22) Filed: Sep. 2, 2025

(30) Foreign Application Priority Data
Dec. 31, 2024 (KR) 10-2024-0202761
Dec. 31, 2024 (KR) 10-2024-0202765
Dec. 31, 2024 (KR) 10-2024-0202766

(51) Int. Cl. F16D 55/226; F16C 19/06; F16D 65/18; F16D 125/40

(52) U.S. Cl. CPC F16D 55/226; F16C 19/06; F16D 65/18; F16C 2326/01; F16D 2125/40

(57) ABSTRACT

Disclosed is a vehicle brake system including a caliper body including a cylinder, a piston part that is movably disposed on the cylinder and disposed to face a brake pad, a nut screw part that is disposed inside the piston part and rotates by receiving rotational force from an actuator, a bolt screw part including a bolt body coupled to the nut screw part and receiving the rotational force from the nut screw part, and a bolt head provided separately from the bolt body, coupled to the bolt body, and disposed to face the piston part, and a bearing part including an outer ring part in contact with an inner surface of the cylinder and a bearing ball disposed between the outer ring part and the nut screw part.

### CROSS-REFERENCE TO RELATED APPLICATION

This application claims the benefit under 35 U.S.C. § 119(a) of priority to Korean Patent Applications No. 10-2024-0202761, No. 10-2024-0202765, and No. 10-2024-0202766 filed on Dec. 31, 2024, in the Korean Intellectual Property Office, the entire disclosure of which is incorporated herein by reference for all purposes.

### BACKGROUND

### 1. Technical Field

Exemplary embodiments of the present disclosure relate to vehicle brake systems, and more particularly, to vehicle brake systems capable of securing stable braking performance.

### 2. Related Art

Typically, a vehicle brake system pushes a piston with driving force to bring a brake pad and a brake disc into contact, and uses the frictional force between the brake pad and the brake disc to brake a vehicle. Among the vehicle brake systems, an electro-mechanical brake (EMB) device generates braking force without using hydraulic pressure by mounting a motor-driven actuator on a caliper to pressurize a piston through a mechanism in which the motor-driven actuator converts the rotary motion of a screw into the linear motion of a nut or converts the rotary motion of the nut into the linear motion of the screw.

The EMB device is capable of active braking and independent braking for each wheel, so that not only general main movement but also additional functions such as anti-lock brake system (ABS), electric stability control (ESC), traction control system (TCS), and automatic emergency braking (AEB) can be implemented, and higher performance can be implemented because there is no delay in hydraulic delivery.

The background technology of the present disclosure is disclosed in Korean Patent Publication No. 10-2024-0054695 (published on Apr. 26, 2024, entitled “BRAKE DEVICE FOR VEHICLE”).

### SUMMARY

Various embodiments are directed to vehicle brake systems in which a bolt body and a bolt head of a bolt screw part are manufactured separately.

Various embodiments are directed to vehicle brake systems in which the contact diameter of the bolt head in contact with a piston part can be expanded.

Various embodiments are directed to vehicle brake systems capable of stably supporting a nut screw part when generating and releasing braking force.

Various embodiments are directed to vehicle brake systems capable of reducing the outer diameter of the bolt screw part and the nut screw part assembly.

Various embodiments are directed to vehicle brake systems capable of preventing malfunction or failure by setting a maximum allowable stroke of the bolt screw part.

A vehicle brake system according to first embodiment of the present disclosure may include a caliper body including a cylinder, a piston part that is movably disposed on the cylinder and disposed to face a brake pad, a nut screw part that is disposed inside the piston part and rotates by receiving rotational force from an actuator, a bolt screw part including a bolt body coupled to the nut screw part and receiving the rotational force from the nut screw part, and a bolt head provided separately from the bolt body, coupled to the bolt body, and disposed to face the piston part, and a bearing part including an outer ring part in contact with an inner surface of the cylinder and a bearing ball disposed between the outer ring part and the nut screw part.

The outer ring part may include a bearing ball contact part on which the bearing ball is seated, an outer ring bottom part connected to a first side of the bearing ball contact part and having the same height as a region of the bearing ball contact part that which contacts the outermost region of the bearing ball; and an outer ring step part connected to a second side of the bearing ball contact part and protruding further toward the nut screw part than the outer ring bottom part.

The outer ring bottom part may protrude toward the nut screw part to be disposed further inside than an outermost region of the bearing ball.

The nut screw part may include a rolling contact part on which the bearing ball is seated, a nut bottom part connected to a first side of the rolling contact part, and a nut step part connected to a second side of the rolling contact part and protruding further toward the outer ring part than the nut bottom part.

The nut bottom part may protrude toward the outer ring part to be disposed further outward than an innermost region of the bearing ball.

The bearing ball contact part may include a first outer contact region disposed on the outer ring step part side with respect to the outermost region of the bearing ball, and a second outer contact region disposed on the outer ring bottom part side, and the rolling contact part may include a first inner contact region disposed on the nut step part side with respect to the innermost region of the bearing ball, and a second inner contact region disposed on the nut bottom part side.

The first outer contact region and the first inner contact region may be disposed to face each other diagonally based on the bearing ball, and the bearing ball may be supported by contacting the first outer contact region and the first inner contact region when the bolt screw part moves toward the piston part.

The second outer contact region and the second inner contact region may be disposed to face each other in a diagonal direction based on the bearing ball, and the bearing ball may be supported by contacting the second outer contact region and the second inner contact region when the bolt screw part moves toward the opposite side of the piston part.

The bolt head may include a head connection part that is coupled to the bolt body and has a larger diameter than an outer diameter of the bolt body, and a head expansion part that extends from the head connection part toward the piston part and has an outer diameter larger than the outer diameter of the head connection part.

The head expansion part may have a curved surface region around an outer periphery toward the piston part, and the head expansion part may be in rolling contact with the piston part on the curved surface region.

A vehicle brake system according to second embodiment of the present disclosure may include a caliper body including a cylinder, a piston part that is movably disposed on the cylinder and disposed to face a brake pad, a nut screw part that is disposed inside the piston part, rotates by receiving rotational force from an actuator, and including an outer ball rail that forms a circulation path of ball members on an inner circumferential surface, and a bolt screw part including a bolt body coupled with the nut screw part and receiving the rotational force from the nut screw part and a bolt head provided separately from the bolt body, coupled with the bolt body, and disposed to face the piston part, wherein an inner ball rail is provided on an outer circumferential surface of the bolt body to face the outer ball rail and forms a circulation path of the ball members. The nut screw part may include a first return hole unit through which the ball members enter and exit, a return passage communicating with the first return hole unit, and a second return hole unit communicating with the return passage and through which the ball members enter and exit.

The ball members entering the first return hole unit may be guided to the second return hole unit through the return passage, and the ball members entering the second return hole unit may be guided to the first return hole unit through the return passage.

The first return hole unit may be disposed closer to the piston part than the second return hole unit.

The vehicle brake system may further include a bearing part having an outer ring part in contact with an inner surface of the cylinder, and a bearing ball disposed between the outer ring part and the nut screw part.

The outer ring part may include a bearing ball contact part on which the bearing ball is seated, an outer ring bottom part connected to a first side of the bearing ball contact part, and an outer ring step part connected to a second side of the bearing ball contact part and protruding further toward the nut screw part than the outer ring bottom part.

The nut screw part may include a rolling contact part on which the bearing ball is seated, a nut bottom part connected to a first side of the rolling contact part and having the same height as a part of the bearing ball contact part that comes into contact with an innermost part of the bearing ball, and a nut step part connected to the other side of the rolling contact part and protruding further toward a second ring part than the nut bottom part.

The outer ring step part and the nut step part may be disposed to face each other diagonally with respect to the bearing ball.

The bolt head may include a head connection part that is coupled to the bolt body and has a larger diameter than an outer diameter of the bolt body, and a head expansion part that extends from the head connection part toward the piston part and has an outer diameter larger than the outer diameter of the head connection part.

The head expansion part may have a curved surface region around an outer periphery toward the piston part, and the head expansion part may be in contact with the piston part on the curved surface region.

When the piston part is inclined with respect to a central axis, the head expansion part may roll with respect to the piston part in the curved surface region, and the nut screw part may roll with respect to the bearing part.

A vehicle brake system according to third embodiment of the present disclosure may include a caliper body including a cylinder, a piston part that is movably disposed on the cylinder and disposed to face a brake pad, a nut screw part that is disposed inside the piston part and rotates by receiving rotational force from an actuator, and a bolt screw part including a bolt body that is coupled with the nut screw part to receive the rotational force from the nut screw part, and a bolt head that is separately provided from the bolt body to be coupled with the bolt body and disposed to face the piston part, wherein when the bolt body is moved toward the piston part by a set distance, movement toward the piston part is blocked by the nut screw part.

The bolt body may be provided with a stopper protrusion, and a stopper is provided on an inner circumferential surface of the nut screw part, and when the stopper protrusion is in contact with the stopper, the bolt body may be blocked from moving inside the nut screw part.

The stopper protrusion may protrude further outward than an outer circumferential surface of the bolt body, and the stopper may protrude further inward than an inner circumferential surface of the nut screw part.

The stopper protrusion may be press-fitted or bolted to the bolt body to be integrated, and the stopper may be press-fitted or bolted to the nut screw part to be integrated.

An outer diameter of the bolt head may be larger than the outer diameter of the bolt body.

The bolt head may include a head connection part that is coupled to the bolt body, and a head expansion part that extends from the head connection part toward the piston part and has an outer diameter larger than the outer diameter of the head connection part.

The head expansion part may have a curved surface region around an outer periphery toward the piston part, and the head expansion part may be in contact with the piston part on the curved surface region.

When the piston part is inclined with respect to a central axis, the head expansion part may roll with respect to the piston part on the curved surface region.

The vehicle brake system may further include a bearing part that is disposed between the cylinder and the nut screw part and supports the nut screw part so that the nut screw part rotates inside the cylinder, and when the piston part is inclined with respect to a central axis, the nut screw part rolls with respect to the bearing part.

The vehicle brake system may further include a bearing part that is disposed between the cylinder and the nut screw part and supports the nut screw part so that the nut screw part rotates inside the cylinder, and when the piston part is inclined with respect to a central axis, the nut screw part may roll with respect to the bearing part.

The bearing part may include an outer ring part that comes into contact with an inner surface of the cylinder, and a bearing ball disposed between the outer ring part and the nut screw part, and the nut screw part may include a rolling contact part at a portion facing the bearing ball.

According to the present disclosure, because the bolt head is manufactured as a separate product from the bolt body, the shape flexibility of the bolt head can be improved.

According to the present disclosure, as the contact diameter of the bolt head in contact with the piston part is enlarged, load can be stably transmitted to the piston part.

According to the present disclosure, when the braking force is generated and released, bearing balls come into contact with a rolling contact part and a bearing ball contact portion, so that the load of the nut screw part can be stably supported.

According to the present disclosure, because the bearing part is configured in two-point bearing, assembly is easy and the ball size can be reduced, so that the outer diameter of the bolt screw part and nut screw part assembly can be reduced.

According to the present disclosure, because a return path is separately provided in the nut screw part, the ball member can be repeatedly circulated and operated on an outer ball rail and an inner ball rail, thereby stably converting and transmitting the rotational torque into an axial load.

According to the present disclosure, because the maximum allowable stroke of the bolt screw part is set by a stopper protrusion and a stopper, malfunction or failure of the vehicle brake system can be prevented in advance.

### BRIEF DESCRIPTION OF THE DRAWINGS

FIG. 1 is a perspective view schematically illustrating a vehicle brake system according to first embodiment of the present disclosure.

FIG. 2 is a cross-sectional view schematically illustrating a vehicle brake system according to first embodiment of the present disclosure.

FIG. 3 is a partially enlarged view of FIG. 2.

FIG. 4 is a partially enlarged view of FIG. 3.

FIG. 5 is an enlarged view illustrating a bearing part of a vehicle brake system according to first embodiment of the present disclosure.

FIG. 6 is a perspective view illustrating an actuator part of a vehicle brake system according to first embodiment of the present disclosure.

FIG. 7 is a cross-sectional view schematically illustrating a vehicle brake system according to second embodiment of the present disclosure.

FIG. 8 is a view schematically illustrating a return path of a ball member in a vehicle brake system according to second embodiment of the present disclosure.

FIG. 9 is a partially enlarged view of FIG. 7.

FIG. 10 is a partially enlarged view of FIG. 9.

FIG. 11 is a cross-sectional view schematically illustrating a vehicle brake system according to third embodiment of the present disclosure.

FIG. 12 is a cross-sectional view illustrating a nut screw part and a bolt screw part of a vehicle brake system according to third embodiment of the present disclosure.

FIG. 13 is a cross-sectional perspective view illustrating a nut screw part and a bolt screw part of a vehicle brake system according to third embodiment of the present disclosure.

FIG. 14 is a partially enlarged view of FIG. 11.

FIG. 15 is a partially enlarged view of FIG. 14.

### DETAILED DESCRIPTION

Hereinafter, vehicle brake systems according to the present disclosure will be described in detail below with reference to the accompanying drawings through various exemplary embodiments. It should be considered that the thickness of each line or the size of each component in the drawings may be exaggeratedly illustrated for clarity and convenience of description. In addition, terms to be described below have been defined by taking into consideration their functions in the present disclosure, and may be different depending on a user or operator's intention or practice. Accordingly, such terms should be interpreted based on the overall contents of this specification.

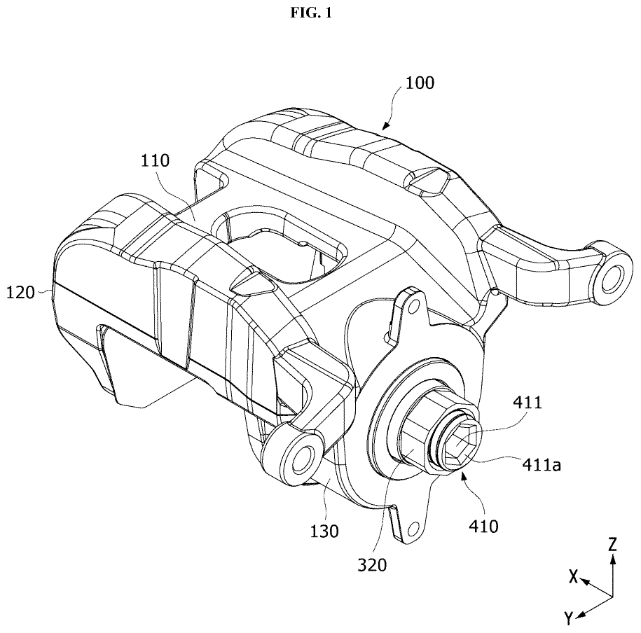

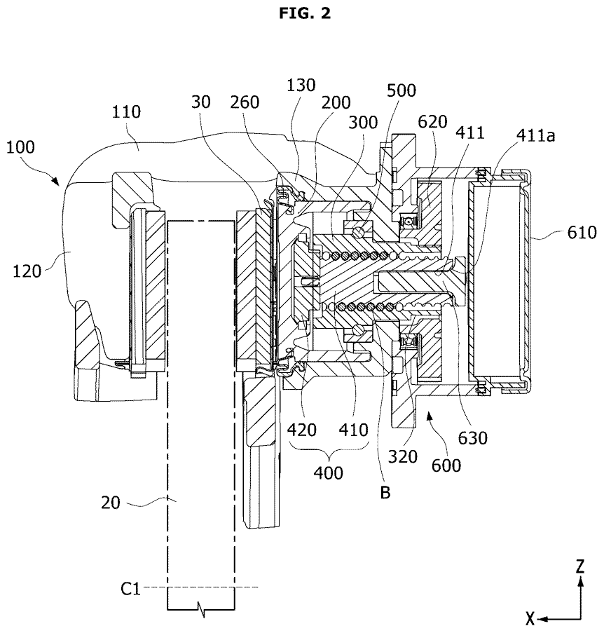

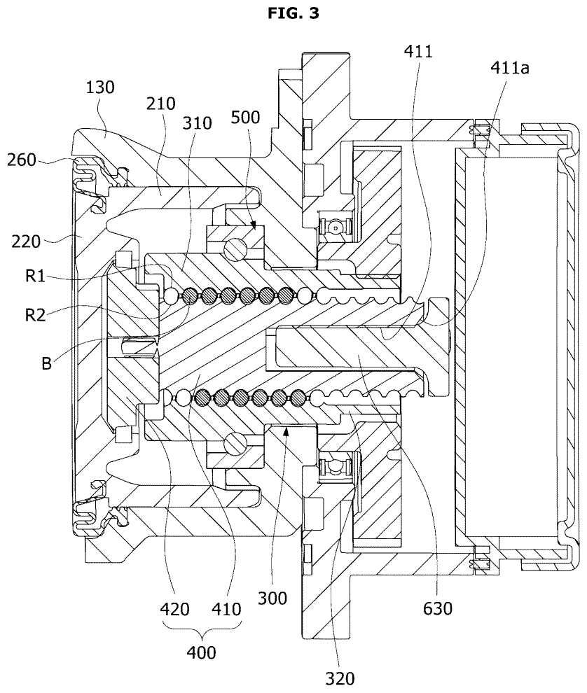

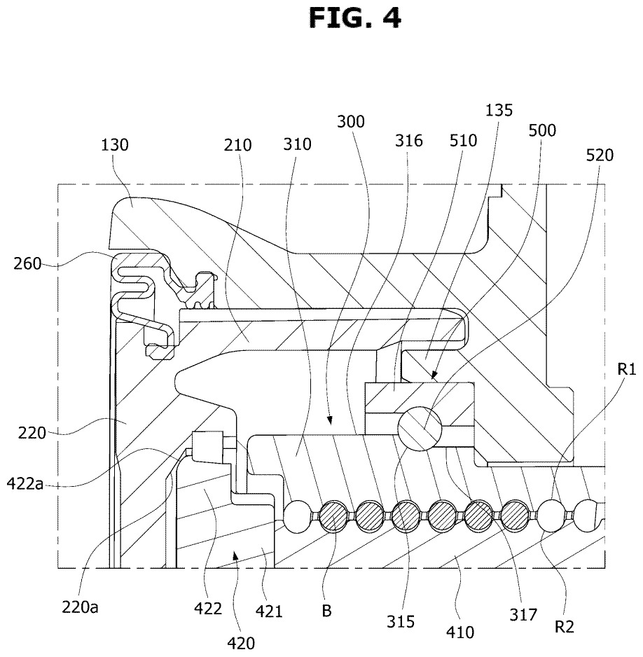

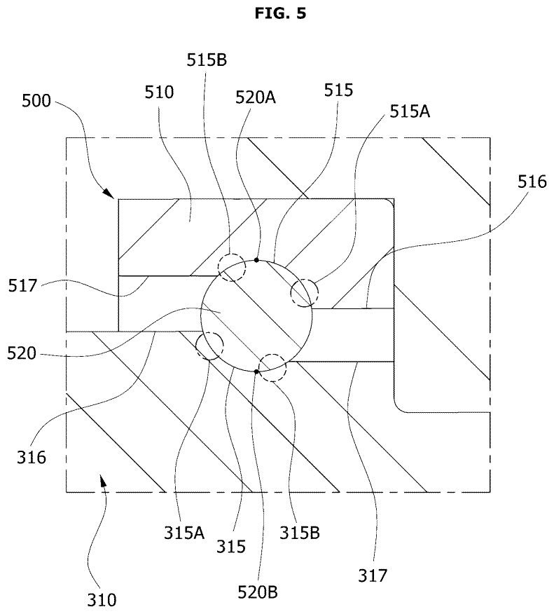

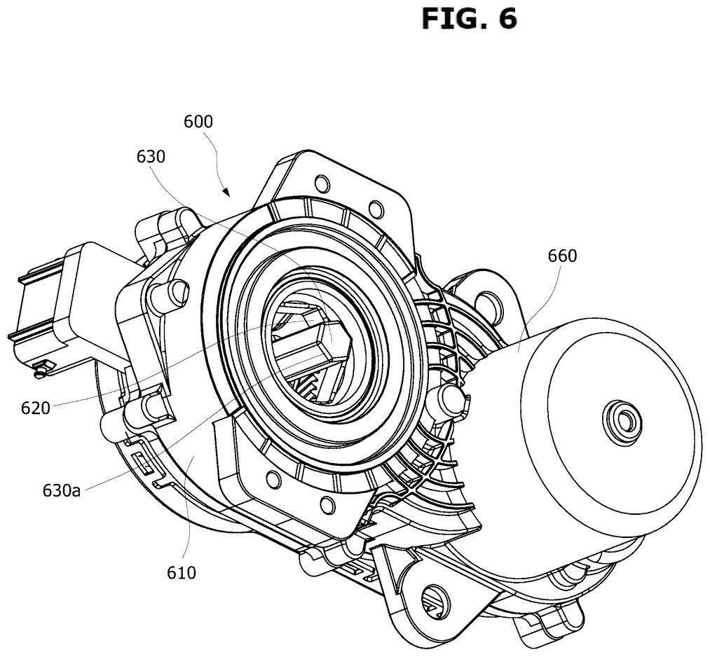

FIG. 1 is a perspective view schematically illustrating a vehicle brake system according to first embodiment of the present disclosure, FIG. 2 is a cross-sectional view schematically illustrating the vehicle brake system according to the first embodiment of the present disclosure, FIG. 3 is a partially enlarged view of FIG. 2, FIG. 4 is a partially enlarged view of FIG. 3, FIG. 5 is an enlarged view illustrating a bearing part of the vehicle brake system according to the first embodiment of the present disclosure, and FIG. 6 is a perspective view illustrating an actuator part of the vehicle brake system according to the first embodiment of the present disclosure.

Referring to FIG. 1 to FIG. 6, the vehicle brake system according to the embodiment of the present disclosure includes a caliper body 100, a piston part 200, a nut screw part 300, and a bolt screw part 400.

The caliper body 100 forms the outer shape of the vehicle brake system and surrounds or supports the piston part 200, the nut screw part 300, and the bolt screw part 400. The caliper body 100 includes a bridge 110, a finger 120, and a cylinder 130.

The bridge 110 forms the appearance of a central portion of the caliper body 100 and supports the finger 120 and the cylinder 130. The bridge 110 may be connected to a carrier (not shown) fixed to a knuckle (not shown) or the like via a guide rod (not shown).

A lower surface of the bridge 110 is positioned to face a circumferential surface of a brake disc 20 at a set interval. Both sides of the bridge 110 extend along a first direction (+X direction as shown in FIG. 2) and a second direction (−X direction as shown in FIG. 2) opposite to the first direction, with respect to the brake disc 20.

A pair of brake pads 30 are disposed below the bridge 110. The pair of brake pads 30 are disposed to face each other with the brake disc 20 therebetween.

A friction pad including a material with a high coefficient of friction, such as rubber, may be attached to one side of each of the brake pads 30 facing the brake disc 20.

The finger 120 extends downward from a first side of the bridge 110. The finger 120 is disposed to face one of the pair of brake pads 30.

The cylinder 130 extends downward from a second side of the bridge 110. The cylinder 130 may have a columnar shape with an empty interior. One side (left side in FIG. 2) of the cylinder 130 is disposed to face the other one of the pair of brake pads 30.

One side of the cylinder 130 is opened, and the opened side of the cylinder 130 is spaced apart from the brake pad 30 by a set interval, which is spaced apart from the brake disc 20 in the second direction.

A central axis of the cylinder 130 is parallel to a central axis C1 of the brake disc 20. The central axis of the cylinder 130 is spaced apart from the central axis C1 of the brake disc 20 in a third direction (+Z direction based on FIG. 2).

The third direction may be exemplified as a direction perpendicular to the first and second directions and extends from the central axis C1 of the brake disc 20 toward the central axis of the cylinder 130.

When the lower surface of the bridge 110 is parallel to the ground, the third direction may be a direction perpendicular to the ground, that is, the direction rising along the Z-axis direction based on FIG. 2.

The piston part 200 is disposed in the cylinder 130 to be movable in the first direction (+X direction based on FIG. 2) or the second direction (−X direction based on FIG. 2). The piston part 200 is disposed inside the cylinder 130.

The piston part 200 has a columnar shape with an interior that is hollow. The sides of the piston part 200 facing the brake pads 30 may be closed. The piston part 200 may be disposed along a longitudinal direction of the cylinder 130.

An outer surface of the piston part 200 is slidably supported on an inner surface of the cylinder 130. Alternatively, the outer surface of the piston part 200 may be spaced apart from the inner surface of the cylinder 130 by a set interval.

The piston part 200 protrudes outward from the cylinder 130 as moving in the first direction, and pressurizes the brake pads 30 positioned facing the cylinder 130 toward the brake disc 20. As a result, the vehicle brake system generates braking force.

When the piston part 200 moves in the second direction, the piston part 200 becomes separated from the brake pads 30. As a result, the pressing force applied by the piston part 200 to the brake pads 30 is released, and the braking force of the vehicle brake system disappears.

The piston part 200 includes a piston body 210 and a piston head 220.

The piston body 210 has a hollow columnar shape, and the piston head 220 is connected to the piston body 210 to close one side (left side in FIG. 2) of the piston body 210. The piston head 220 is disposed on one of the open sides of the piston body 210, facing the brake pad 30 to close the open area of the piston body 210.

The bolt screw part 400 is disposed inside the piston part 200. A bolt body 410 and a bolt head 420 of the bolt screw part 400 are surrounded by the piston body 210. The bolt head 420 is disposed to be inserted into the piston head 220.

A piston boot 260 that prevents inflow of external foreign substances and water-tightens the inside of the cylinder 130 is installed inside the cylinder 130. The piston boot 260 is installed between the cylinder 130 and the piston part 200. The piston boot 260 is coupled to the piston body 210 or the piston head 220 and is press-fitted into the inside of the cylinder 130.

The piston boot 260 is disposed to surround the piston part 200. The piston boot 260 includes an elastically deformable material. For example, the piston boot 260 may include a rubber material. The piston boot 260 may have a corrugated shape.

The nut screw part 300 is rotatably disposed in the cylinder 130 and is coupled to the bolt screw part 400. A bearing part 500 that rotatably supports the nut screw part 300 is installed inside the cylinder 130. The bearing part 500 may be a ball bearing disposed between the cylinder 130 and the nut screw part 300.

The nut screw part 300 has a hollow columnar shape with open ends. The nut screw part 300 is disposed inside the cylinder 130, and a central axis of the nut screw part 300 may be positioned on the same axis as the central axis of the cylinder 130

A first side (left side based on FIG. 2) of the nut screw part 300 faces an inner side (right side based on FIG. 2) of the piston part 200 at a set interval. A second side (right side based on FIG. 2) of the nut screw part 300 penetrates the cylinder 130 and protrudes to the outside of the cylinder 130.

The nut screw part 300 is disposed such that an inner surface thereof faces an outer surface of the bolt screw part 400. An outer ball rail R1 on which spherical ball members B are seated is disposed on an inner circumferential surface of the nut screw part 300. The outer ball rail R1 extends in a spiral shape in a longitudinal direction of the nut screw part 300. The outer ball rail R1 of the nut screw part 300 forms a circulation path of the ball members B together with an inner ball rail R2 of the bolt screw part 400 on an opposite side.

The nut screw part 300 receives a rotational force generated from an actuator 600 through a power transmission part when the actuator 600 is operated, and rotates clockwise or counterclockwise around a central axis.

The nut screw part 300 includes a nut screw body 310 and a nut screw tail 320.

Most of the nut screw body 310 is disposed inside the cylinder 130, and the whole or most of the nut screw tail 320 is exposed to the outside of the cylinder 130. The nut screw body 310 is surrounded by the piston body 210.

The nut screw tail 320 has a non-circular column shape. The non-circular shape means a shape that is not a regular circle and encompasses shapes such as an ellipse and a polygon. In the present embodiment, the nut screw tail 320 has a polygonal column shape, specifically, an approximately hexagonal column shape.

The bolt screw part 400 is interlocked with the rotation of the nut screw part 300 to move in the first direction and the second direction inside the cylinder 130. The bolt screw part 400 is disposed inside the nut screw part 300. The bolt screw part 400 is disposed to penetrate both ends of the nut screw part 300.

The bolt screw part 400 moves in the first direction, which is a direction toward the brake pads 30, to move the piston part 200 to pressurize the brake pads 30. In addition, as the bolt screw part 400 is moved in the second direction, which is opposite to the first direction, the pressure on the piston part 200 may be released.

The bolt screw part 400 includes a bolt body 410 and a bolt head 420.

The bolt body 410 is coupled to the nut screw part 300 to receive the rotational force from the nut screw part 300. The bolt head 420 is separately provided from the bolt body 410. The bolt body 410 is press-fitted into the bolt head 420 to be integrated. For example, the bolt body 410 may be serrated and press-fitted into the bolt head 420.

As the bolt head 420 is separately provided from the bolt body 410, the shape flexibility of the bolt head 420 can be improved. Particularly, the shape of the bolt head 420 may be changed according to specifications of the vehicle brake system, and as the bolt head 420 is separately provided from the bolt body 410, which is relatively easy to standardize, customization is easy and the degree of design freedom may be increased. According to the present embodiment, when the size of the piston part 200 is changed, a contact diameter of the bolt head 420 may be easily changed accordingly.

The bolt body 410 is interlocked with the rotation of the nut screw part 300, and the bolt head 420 disposed in front of the bolt body 410 (left side of FIG. 2) presses the piston part 200 when the bolt body 410 is translated in the first direction inside the cylinder 130.

The bolt body 410 has a columnar shape having an approximately circular cross section. The bolt body 410 is disposed inside the cylinder 130, and a central axis of the bolt body 410 is positioned on the same axis as the central axis of the cylinder 130. The bolt body 410 is coupled to the nut screw part 300 via the ball members B.

The inner ball rail R2 on which the ball members B are seated is disposed on the outer circumferential surface of the bolt body 410. The inner ball rail R2 extends in a spiral shape in the longitudinal direction (left and right directions based on FIG. 2) of the bolt body 410 to provide a circulation path for the ball members B. Accordingly, when the nut screw part 300 rotates, the bolt body 410 may be moved in the first direction or the second direction by circulating movement of the ball members B.

The outer ball rail R1 disposed on the inner circumferential surface of the nut screw part 300 and the inner ball rail R2 disposed on the outer circumferential surface of the bolt body 410 are disposed to face each other. The ball members B may have outer parts guided by the outer ball rail R1 and inner parts guided by the inner ball rail R2 to move in a spiral shape along the outer ball rail R1 and the inner ball rail R2.

The bolt head 420 is disposed between the bolt body 410 and the piston part 200. The bolt head 420 may have an approximately circular cross section. The bolt head 420 is disposed to be inserted into the piston head 220. The bolt head 420 is disposed to face an inner surface of the piston head 220 at a set interval. When braking force is not generated or when the braking force is released in the vehicle brake system, the bolt head 420 may be disposed to be spaced apart from the piston head 220.

The bolt head 420 may press the piston head 220. The bolt head 420 may press the piston head 220 or release the pressure of the piston head 220 in the first direction depending on the movement direction of the bolt body 410.

An outer diameter of the bolt head 420 may be greater than the outer diameter of the bolt body 410. Accordingly, when the bolt screw part 400 presses the piston part 200 to be moved toward the brake pads 30, a contact diameter of the bolt screw part 400 in contact with the piston part 200 may be enlarged.

The contact diameter of the bolt head 420 in contact with the piston head 220 is further increased when the outer diameter of the bolt head 420 is greater than the outer diameter of the bolt body 410 than when the outer diameter of the bolt head 420 in contact with the piston head 220 is equal to or smaller than the outer diameter of the bolt body 410. Accordingly, it is possible to improve the efficiency of load transfer to the piston part 200 through the bolt head 420. In addition, as the contact diameter of the bolt head 420 in contact with the piston head 220 is increased, the load can be stably transferred to the piston part 200, and the centering of the bolt screw part 400 can be stably maintained.

The bolt head 420 includes a head connection part 421 and a head expansion part 422.

The head connection part 421 is a part that faces the bolt body 410 from the bolt head 420 and is coupled to the bolt body 410. The head expansion part 422 extends from the head connection part 421 toward the piston head 210 and has an outer diameter greater than the outer diameter of the head connection part 421. Accordingly, the contact diameter of the bolt screw part 400 in contact with the piston part 200 can be enlarged.

The contact diameter of the head expansion part 422 in contact with the piston head 220 is further increased when the outer diameter of the head expansion part 422 is greater than the outer diameter of the head connection part 421 than when the outer diameter of the head expansion part 422 in contact with the piston head 220 is equal to the outer diameter of the head connection part 421. Accordingly, it is possible to improve the efficiency of load transfer to the piston part 200 through the bolt head 420. In addition, as the contact diameter of the head expansion part 422 in contact with the piston head 220 is increased, the load transfer to the piston part 200 becomes more stable.

The head expansion part 422 has a curved surface region 422a on the outer circumference facing the piston head 220. The curved surface region 422a is a curved surface region having a convex shape facing the piston head 220 and is disposed over the entire outer circumference of the head expansion part 422. The head expansion part 422 may come into contact with the piston head 220 on the curved surface region 422a.

The head expansion part 422 may be in rolling contact with the piston head 220 on the curved surface region 422a. That is, the head expansion part 422 may perform rolling movement with respect to the piston head 220 on the curved surface region 422a.

The piston head 220 includes a flat surface region 220a at a region that comes into contact with the curved surface region 422a. Accordingly, when the head expansion part 422 comes into contact with the piston head 220 due to movement of the bolt screw part 400 in the first direction, even if the head expansion part 422 rolls with respect to the piston head 220, the head expansion part 422 including the convex curved surface region 422a and the piston head 220 including the flat surface region 220a can remain in contact with each other.

When the brake disc 20 rubs against the brake pads 30 by the movement of the piston 200 and braking force is generated, the shape of the caliper body 100 may be partially deformed as a reaction to the braking force. As a result, the cylinder 130 and the piston part 200 may be slightly inclined with respect to the central axis compared to the non-braking state. That is, in the braking state, the cylinder 130 and/or the piston part 200 may be inclined at a slight angle with respect to their respective central axes.

When the cylinder 130 and/or the piston part 200 are inclined about their respective central axes, the head expansion part 422 may come into rolling contact with the piston head 220 on the curved surface region 422a. That is, when the cylinder 130 and/or the piston part 200 are inclined about their respective central axes, the head expansion part 422 may roll with respect to the piston head 220 on the curved surface region 422a.

When the cylinder 130 and/or piston part 200 are inclined about their respective central axes, the head expansion part 422 rolls with respect to the piston head 220, so the bolt body 410 coupled with the bolt head 420 is also inclined as much as the angle at which the bolt head 420 is inclined by rolling motion.

In this way, when the cylinder 130 and/or piston 200 are inclined with respect to their respective central axes, the bolt head 420 and the bolt body 410 are also inclined, so that the load can be prevented from being concentrated only on a specific ball member B among the plurality of ball members B arranged in the longitudinal direction of the bolt body 410. Accordingly, it is possible to ensure the robustness of the bolt screw part 400 against inclination of the cylinder 130 and/or piston part 200, thereby improving the durability of the vehicle brake system.

The bearing part 500 is disposed between the cylinder 130 and the nut screw part 300 and supports the nut screw part 300 so that the nut screw part 300 can rotate inside the cylinder 130.

When the cylinder 130 and/or the piston part 200 are inclined about their respective central axes, the nut screw part 300 may come into rolling contact with the bearing part 500. That is, when the cylinder 130 and/or the piston 200 are inclined about their respective central axes, the nut screw part 300 can roll with respect to the bearing part 500.

In this way, when the cylinder 130 and/or piston 200 are inclined with respect to their respective central axes, the nut screw part 300 is also inclined, so that the load of the nut screw part 300 can be prevented from being concentrated only on a specific ball member B among the plurality of ball members B arranged in the longitudinal direction of the bolt body 410. Accordingly, it is possible to ensure the robustness of the bolt screw part 400 against inclination of the cylinder 130 and/or the piston part 200, thereby improving the durability of the vehicle brake system.

The bearing part 500 includes an outer ring part 510 and a bearing ball 520.

The outer ring part 510 is in contact with the inner surface of the cylinder 130. The outer ring part 510 is press-fitted to the cylinder 130, for example, a mounting protrusion 135, and is firmly fixed in position. Because the outer ring part 510 is press-fitted to the cylinder 130, the load applied to the bearing ball 520 can be distributed in the axial direction and/or the outer radial direction through the outer ring part 510.

The bearing ball 520 is disposed between the outer wheel part 510 and the nut screw body 310. In this embodiment, because the nut screw body 310 performs the role of the inner wheel part of the bearing part 500, the outer diameter of the bearing part 500 can be reduced, so that the vehicle brake system can be manufactured more compactly and the number of assembly parts can be reduced, thereby reducing costs.

The outer ring part 510 includes a bearing ball contact part 515, an outer ring step part 516, and an outer ring bottom part 517.

The outer ring part 510 includes the outer ring bottom part 517 formed on the piston head 220 side with respect to the bearing ball contact part 515 and the outer ring step part 516 formed on the nut screw tail 320 side. The outer ring step part 516 protrudes further inward toward the nut screw part 300 compared to the outer ring bottom part 517, and the bearing ball contact part 515 is disposed between the outer ring step part 516 and the outer ring bottom part 517.

The bearing ball contact part 515 is formed as a curved surface region with a concave shape toward the inside, and is disposed over the entire inner circumference of the outer ring part 510. The bearing ball 520 is in direct contact with the bearing ball contact part 515 or is in indirect contact with the bearing ball contact part 515 through another member. In the present embodiment, the bearing ball 520 is seated on the bearing ball contact part 515.

The bearing ball 520 disposed between the outer ring part 510 and the nut screw body 310 has an outermost region 520A and an innermost region 520B. The outermost region 520A is farthest from the center of the bolt screw part 400, on the outer circumferential surface of the bearing ball 520, and the innermost region 520B is closest to the center of the bolt screw part 400, on the outer circumferential surface of the bearing ball 520.

The outer ring step part 516 and the outer ring bottom part 517 protrude toward the nut screw part 300 to be positioned further inward than the outermost region 520A of the bearing ball 520. Accordingly, the outer ring step part 516 and the outer ring bottom part 517 are disposed to surround the outermost region n 520A of the bearing ball 520.

The bearing ball contact part 515 includes a first outer contact region 515A and a second outer contact region 515B. The first outer contact region 515A is disposed on the outer ring step part 516 side with respect to the outermost region 520A of the bearing ball 520, and the second outer contact region 515B is disposed on the outer ring bottom part 517 side with respect to the outermost region 520A of the bearing ball 520. The bearing ball 520 may come into contact with the inner surface of the bearing ball contact part 515 at the first outer contact region 515A and the second outer contact region 515B.

The nut screw body 310 includes a rolling contact part 315, a nut step part 316, and a nut bottom part 317.

Because the nut screw body 310 has a function as an inner ring portion, which is a rotating part of the bearing part 500, the nut screw body 310 rotates with respect to the outer ring part 510. In addition, because the nut screw body 310 is provided with the rolling contact part 315 at a region facing the bearing ball 520, the nut screw body 310 may roll with respect to the bearing ball 520. In addition, because the nut screw body 310 rolls with respect to the bearing ball 520, the angle between the nut screw body 310 and the outer ring part 510 may be changed.

The nut screw body 310 has a nut step part 316 disposed on the piston head 220 side with respect to the rolling contact part 315 and a nut bottom part 317 disposed on the nut screw tail 320 side. The nut step part 316 protrudes further outward toward the outer ring part 510 compared to the nut bottom part 317, and the rolling contact part 315 is disposed between the nut step part 316 and the nut bottom part 317.

The rolling contact part 315 is disposed as a curved surface part with a concave shape toward the inside and is disposed over the entire outer circumference of the nut screw body 310. The bearing ball 520 is in direct contact with the rolling contact part 315 or indirectly contacts the rolling contact part 315 through another member.

Because the rolling contact part 315 has the curved surface, the nut screw body 310 rolls with respect to the bearing ball 520 or the outer ring part 510 on the rolling contact part 315.

The nut step part 316 and the nut bottom part 317 may protrude further outward than the innermost region 520B of the bearing ball 520. Accordingly, the nut step part 316 and the nut bottom part 317 may be disposed to surround the innermost region 520B of the bearing ball 520.

The rolling contact part 315 includes a first inner contact region 315A and a second inner contact region 315B. The first inner contact region 315A is disposed on the nut step part 316 side with respect to the innermost region 520B of the bearing ball 520, and the second inner contact region 315B is disposed on the nut bottom part 317 side with respect to the innermost region 520B of the bearing ball 520. The bearing ball 520 is in contact with the inner surface of the rolling contact part 315 in the first inner contact region 315A and the second inner contact region 315B.

The nut screw part 300 rotates in one direction to generate braking force in the vehicle brake system, and accordingly, the bolt screw part 400 moves toward the piston part 200. In the process in which the braking force is generated in the vehicle brake system, the bearing ball 520 comes into contact with the first inner contact region 315A of the rolling contact part 315 and the first outer contact region 515A of the bearing ball contact part 515 to stably support the load of the nut screw part 300 applied in the direction opposite to the moving direction of the bolt screw part 400. The first inner contact region 315A and the first outer contact region 515A are disposed to face each other in a diagonal direction with respect to the bearing ball 520.

When the braking force of the vehicle brake system is released, the nut screw part 300 rotates in the other direction, and accordingly, the bolt screw part 400 moves toward the opposite side of the piston part 200. In the process of releasing the braking force of the vehicle brake system, the bearing ball 520 comes into contact with the second inner contact region 315B of the rolling contact part 315 and the second outer contact region 515B of the bearing ball contact part 515, and can stably support the load of the nut screw part 300 applied in the opposite direction to the moving direction of the bolt screw part 400. In addition, displacement may be suppressed in the front-rear direction even when the nut screw part 300 is rotated, and zero drag may be performed when separated from the piston part 200. The second inner contact region 315B and the second outer contact region 515B are disposed to face each other in a diagonal direction with respect to the bearing ball 520.

During braking of the vehicle brake system, the piston part 200 may be inclined with respect to the central axis or the cylinder 130 may be inclined with respect to the central axis by braking torque or opening of the caliper body 100. According to the present embodiment, because the bolt head 420 performs rolling motion with respect to the piston part 200, it is possible to prevent a load from being concentrated on only a specific ball member B among the plurality of ball members B disposed on the outer surface of the bolt screw part 400. In addition, according to the present embodiment, because the nut screw part 300 moves in a rolling motion against the bearing part 500, it is possible to prevent the load from being concentrated on only a specific ball member B among the plurality of ball members B disposed on the inner surface of the nut screw part 300.

The vehicle brake system according to the present embodiment can move in a rolling motion in the front of the bolt screw part 400, in the outer part of the nut screw 300, or in the front of the bolt screw part 400 and the outer of the nut screw 300, so that it is possible to suppress a specific ball member B from receiving a concentrated load even when the piston part 200 is inclined with respect to the central axis or the cylinder 130 is inclined with respect to the central axis. Accordingly, the vehicle brake system according to the present embodiment can improve device durability while securing robustness against inclination.

The vehicle brake system according to an embodiment of the present disclosure further includes an actuator part 600.

The actuator part 600 receives power from the motor part 660 to provide rotational force to the nut screw part 300.

The actuator part 600 includes a power transmission part. The power transmission part may be engaged with the nut screw part 300 to transmit the rotational force to the nut screw part 300. While the nut screw part 300 is rotated by the rotational force provided by the actuator part 600, the bolt screw part 400 may be translated.

The present embodiment provides a nut screw-driven type vehicle brake system in which the nut screw part 300 is first rotated by receiving the rotational force from the actuator part 600, and the bolt screw part 300 and the bolt screw part 400 that are power-coupled by the ball members B are continuously rotated. Therefore, according to the present embodiment, the axial length can be reduced compared to the bolt screw-driven type vehicle brake system.

The power transmission part may include a plurality of gears sequentially engaged and coupled between a motor part 660 and the nut screw part 300. The power transmission part is not limited to such a configuration, and the design may be changed to various types of power transmission means capable of rotating the nut screw part 300 by receiving the rotational force from the motor part 660.

The power transmission part includes a power transmission groove 620 disposed inside an actuator housing 610.

The power transmission groove 620 is disposed to surround a rotation prevention protrusion 630, and the nut screw tail 320 of the nut screw part 300 may be inserted therein.

The power transmission groove 620 is disposed in a shape corresponding to the nut screw tail 320 to be engaged with the nut screw tail 320. The power transmission groove 620 may be formed as a non-circular groove. The non-circular shape means a shape other than a regular circle and includes a shape such as an ellipse, a polygon, etc. In the present embodiment, the power transmission groove 620 is formed as a polygonal groove, specifically, an approximately hexagonal groove.

Because each of the nut screw tail 320 and the power transmission groove 620 has a non-circular shape but has the same shape or the corresponding shape, the nut screw tail 320 and the power transmission groove 620 are engaged with each other when the nut screw tail 320 is inserted into the power transmission groove 620. Accordingly, when the power transmission groove 620 is rotated during the operation of the actuator part 600, the nut screw tail 320 engaged with the power transmission groove 620 is also rotated in the same direction. Accordingly, the rotational force of the actuator part 600 can be stably transmitted to the nut screw part 300 without loss.

The actuator part 600 may include a rotation prevention part. The rotation prevention part may restrict the rotation of the bolt screw part 400 by being engaged with the bolt screw part 400. While the nut screw part 300 is rotated by the rotational force provided by the actuator part 600, the bolt screw part 400 is translated.

Because the nut screw part 300 and the bolt screw part 400 are power-coupled through the ball members B, the rotation of the bolt screw part 400 is blocked by the rotation prevention part so that the rotation of the nut screw part 300 is converted into the translation of the bolt screw part 400.

The rotation prevention part includes the rotation prevention protrusion 630. The rotation prevention protrusion 630 is disposed inside the actuator housing 610 and protrudes to the outside of the actuator housing 610. The rotation prevention protrusion 630 is disposed inside the power transmission groove 620.

When the nut screw tail 320 is inserted into the power transmission groove 620 and engaged with each other, the rotation prevention protrusion 630 is inserted into a rotation prevention groove 411 of the bolt body 410 and engaged with each other. In this way, according to the present embodiment, the power transmission to the nut screw part 300 and rotation prevention to the bolt screw part 400 can be performed by one assembly, and thus, assemblability may be greatly improved.

The rotation prevention protrusion 630 may have a non-circular column shape. The non-circular means a shape that is not a regular circle, and includes shapes such as an oval or polygon. In the present embodiment, the rotation prevention protrusion 630 has a polygonal column shape, specifically, an approximately hexagonal column shape.

The rotation prevention groove 411 is disposed in the bolt body 410 in a shape corresponding to the rotation prevention protrusion 630 to be engaged with the rotation prevention protrusion 630. The rotation prevention groove 411 may be formed as a non-circular groove part. The non-circular shape means a shape other than a regular circle and includes a shape such as an ellipse or a polygon. In the present embodiment, the rotation prevention groove 411 is formed as a polygonal groove, specifically, an approximately hexagonal groove.

Because each of the rotation prevention protrusion 630 and the rotation prevention groove 411 has a non-circular shape and but has the same shape or the corresponding shape, the rotation prevention protrusion 630 and the rotation prevention groove 411 are engaged with each other when the rotation prevention protrusion 630 is inserted into the rotation prevention groove 411. Accordingly, when the power transmission groove 620 is rotated during the operation of the actuator part 600, the nut screw tail 320 engaged with the power transmission groove 620 is rotated in the same direction, but the rotation of the bolt body 410 is blocked. Accordingly, the rotational force of the actuator part 600 can be stably switched into the translational movement of the bolt screw part 400 without loss.

The rotation prevention protrusion 630 and the rotation prevention groove 411 are in surface contact with each other, so that loss of frictional force can be reduced and the centering of the bolt body 410 can be held when an axial forward load is generated. In addition, because the rotation prevention groove 411 may be integrally formed with the bolt body 410, there is no need to separately manufacture a rotation prevention structure and space utilization can be increased.

The rotation prevention groove 411 includes an expanded inclined surface 411a that is expanded outwardly to induce the insertion of the rotation prevention protrusion 630. The rotation prevention protrusion 630 includes an inclined surface region 630a tapered outside of the front end to be more easily inserted into the rotation prevention groove 411.

The length at which the rotation preventing protrusion 630 is inserted into the bolt body 410 may be greater than the maximum stroke of the piston part 200. The maximum stroke of the piston part 200 refers to a distance by which the piston part 200 moves from the original point to the maximum forward point, and the stroke of the piston part 200 can be increased by the amount worn when the brake pad 30 is worn. Therefore, the length at which the rotation prevention protrusion 630 is inserted into the bolt body 410 is greater than the maximum stroke of the piston part 200, and thus, the rotation prevention protrusion 630 is always engaged with the rotation prevention groove part 411 of the bolt body 410, and the rotation of the bolt screw part 400 can be always blocked.

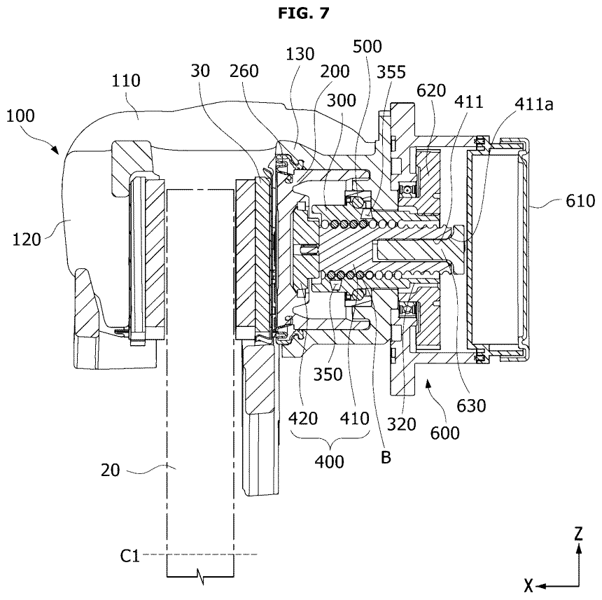

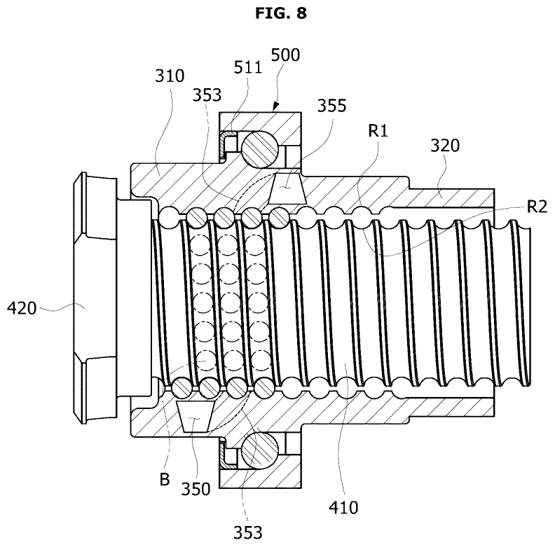

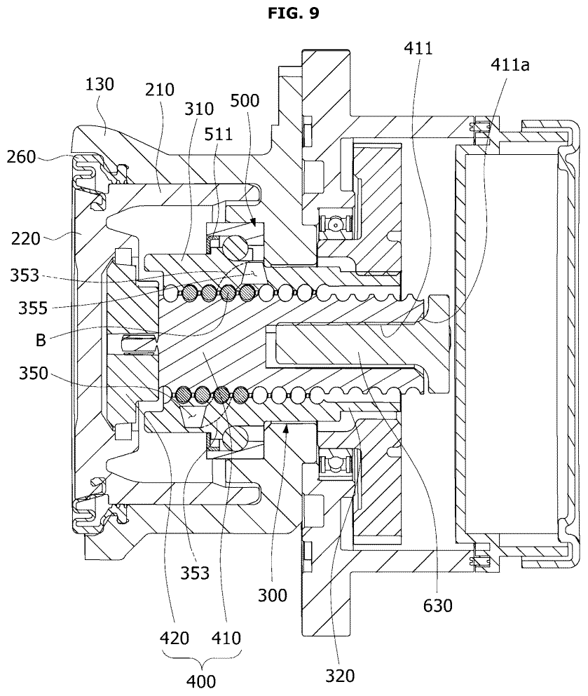

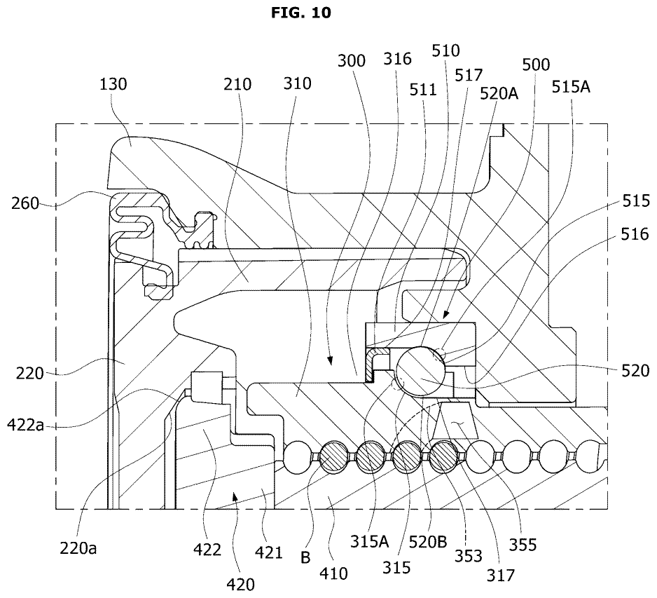

FIG. 7 is a cross-sectional view schematically illustrating a vehicle brake system according to second embodiment of the present disclosure, FIG. 8 is a view schematically illustrating a return path of a ball member in the vehicle brake system according to the second embodiment of the present disclosure, FIG. 9 is a partially enlarged view of FIG. 7, and FIG. 10 is a partially enlarged view of FIG. 9.

Referring to FIG. 7 to FIG. 10 together with FIG. 1 and FIG. 6, the vehicle brake system according to the second embodiment of the present disclosure includes a caliper body 100, a piston part 200, a nut screw part 300, and a bolt screw part 400. The vehicle brake system according to the second embodiment of the present disclosure is different only in some configurations from the vehicle brake system according to the first embodiment in FIG. 1 to FIG. 6, and thus a description of the same configurations as the vehicle brake system according to the first embodiment in FIG. 1 to FIG. 6 is omitted below.

The caliper body 100 includes a bridge 110, a finger 120, and a cylinder 130.

The piston part 200 includes a piston body 210 and a piston head 220.

The nut screw part 300 includes a nut screw body 310 and a nut screw tail 320.

An outer ball rail R1 disposed on an inner circumferential surface of the nut screw part 300 and an inner ball rail R2 formed on an outer circumferential surface of the bolt body 410 are disposed to face each other. Each of ball members B has an outer portion guided by the outer ball rail R1 and an inner portion guided by the inner ball rail R2 to move in a spiral shape along the outer ball rail R1 and the inner ball rail R2.

The nut screw part 300 includes a return path that moves the ball members B on a first side of the outer ball rail R1 and the inner ball rail R2 to a second side on the outer ball rail R1 and the inner ball rail R2. The return path of the nut screw part 300 includes a first return hole unit 350, a return passage 353, and a second return hole unit 355.

The first return hole unit 350 has an inner diameter larger than an outer diameter of each of the ball members B so that the ball members B running on the outer ball rail R1 and the inner ball rail R2 may enter and exit. The first return hole unit 350 is disposed to communicate with the outer ball rail R1 and the inner ball rail R2 so that the ball members B may enter or exit.

The second return hole unit 355 has the inner diameter larger than the outer diameter of the ball member B so that the ball members B running on the outer ball rail R1 and the inner ball rail R2 may enter and exit. The second return hole unit 355 is disposed to communicate with the outer ball rail R1 and the inner ball rail R2 so that the ball members B may enter or exit. The second return hole unit 355 is formed at a different point from the first return hole unit 350. In the present embodiment, the first return hole unit 350 may be disposed closer to the piston part 200 than the second return hole unit 355.

The return passage 353 has one side communicating with the first return hole unit 350 and the other side communicating with the second return hole unit 355 to connect the first return hole unit 350 with the second return hole portion 355. Therefore, the ball members B entering the first return hole unit 350 are guided to the second return hole unit 355 through the return passage 353 and advance onto the outer ball rail R1 and the inner ball rail R2 again. The ball members B entering the second return hole unit 355 are guided to the first return hole unit 350 through the return passage 353 and advance onto the outer ball rail R1 and the inner ball rail R2 again.

The first return hole unit 350 and the second return hole unit 355 allow the ball members B to enter and exit. For example, in a process in which the braking force is generated in the vehicle brake system, that is, when the bolt screw part 400 is moved toward the piston part 200, the ball members B may enter the first return hole unit 350 and may exit from the second return hole unit 355. Conversely, when the braking force is released from the vehicle brake system, that is, when the bolt screw part 400 is moved to the opposite side of the piston part 200, the ball members B may enter the second return hole unit 355 and exit from the first return hole unit 350.

Based on the process of generating the braking force in the vehicle brake system, when the bolt screw part 400 is moved toward the piston part 200 by the rotation of the nut screw part 300 and reaches a set point, where the first return hole unit 350 is disposed in the present embodiment, the ball members B enter the first return hole unit 350 side by continuous rotation of the nut screw part 300. Thereafter, the ball members B are guided to the second return hole unit 355 through the return passage 353, exit from the second return hole unit 355, and disposed on the outer ball rail R1 and the inner ball rail R2 again. When the rotation of the nut screw part 300 continues, the ball members B travel along the outer ball rail R1 and the inner ball rail R2 from the point where the second return hole unit 355 is disposed, reach the point where the first return hole unit 350 is disposed, and then enter the first return hole the ball unit 350 again. Accordingly, recirculation of the ball members B can be continued.

Based on the process of releasing the braking force of the vehicle brake system, when the bolt screw part 400 is moved to the opposite side of the piston part 200 by the rotation of the nut screw part 300 and the ball members B reach the point where the second return hole unit 355 is disposed, the ball members B enter the second return hole unit 355 by the continuous rotation of the nut screw part 300. Thereafter, the ball members B are guided to the first return hole unit 350 through the return passage 353, exit from the first return hole unit 350, and disposed again on the outer ball rail R1 and the inner ball rail R2. When the rotation of the nut screw part 300 continues, the ball members B travel along the outer ball rail R1 and the inner ball rail R2 from the point where the first return hole unit 350 is disposed, reach the point where the second return hole unit 355 is disposed, and enter the second return hole unit 355 again. Accordingly, recirculation of the ball members B can be continued.

According to the present embodiment, because the return path is separately provided in the nut screw part 300, the ball members B can be repeatedly circulated and operated on the outer ball rail R1 and the inner ball rail R2. Accordingly, durability between the nut screw part 300 and the bolt screw part 400 can be improved, and the rotational torque can be stably converted into the shaft and transmitted during the braking operation or release operation of the vehicle brake system.

The bolt screw part 400 includes a bolt body 410 and a bolt head 420, and the bolt head 420 includes a head connection part 421 and a head expansion part 422.

The bearing part 500 includes an outer ring part 510 and a bearing ball 520. The outer ring part 510 includes a bearing ball contact part 515, an outer ring step part 516, and an outer ring bottom part 517.

The outer ring part 510 includes the outer ring bottom part 517 formed at the piston head 220 side with respect to the bearing ball contact part 515, and the outer ring step part 516 formed at the nut screw tail 320 side. The outer ring step part 516 protrudes further inward toward the nut screw part 300 than the outer ring bottom part 517, and the bearing ball contact part 515 is disposed between the outer ring step part 516 and the outer ring bottom part 517.

The bearing ball contact part 515 has a curved surface region concave toward the inside, and is disposed over the entire inner circumference of the outer ring part 510. The bearing ball 520 is in direct contact with the bearing ball contact part 515 or indirectly contacts the bearing ball contact part 515 through another member. In the present embodiment, the bearing ball 520 may be seated on the bearing ball contact part 515.

The bearing ball 520 disposed between the outer ring part 510 and the nut screw body 310 includes an outermost region 520A and an innermost region 520B. The outermost region 520A is a region of the outer circumferential surface where the bearing ball 520 is farthest from the center of the bolt screw part 400, and the innermost region 520B is a region of the outer circumferential surface where the bearing ball 520 is closest to the center of the bolt screw part 400.

The outer wheel bottom part 517 has the same height as a region of the bearing ball contact part 515, contacting the outermost region 520A of the bearing ball 520 or the outermost region 520A of the bearing ball 520.

The bearing ball contact part 515 may include an outer contact region 515A. The outer contact region 515A is closer to the outer wheel step part 516 than the outer wheel bottom part 517 with respect to the outermost region 520A of the bearing ball 520. The bearing ball 520 may be in contact with the inner surface of the bearing ball contact part 515 at the outer contact region 515A.

The bearing part 500 further includes a bearing cover 511. A first side of the bearing cover 511 is press-fitted to an inner surface of the outer ring part 510, and a second side of the bearing cover 511 extends toward the nut screw body 310. The bearing cover 511 is disposed in front of the nut step part 316 so that the nut screw body 310 restrains movement beyond a set range. That is, because the bearing cover 511 is spaced a set distance from the front of the nut step part 316, when the nut screw body 310 is moved by a set range with respect to the outer ring part 510, further movement of the nut step part 316 may be blocked by the bearing cover 511. Thus, it is possible to prevent the relative movement between the nut screw part 300 and the cylinder 130 from being out of a set range.

The nut screw body 310 includes a rolling contact part 315, a nut step part 316, and a nut bottom part 317. The rolling contact part 315 is formed as a curved surface region concave toward the inside and is disposed over the entire outer circumference of the nut screw body 310. The bearing ball 520 may be in direct contact with the rolling contact part 315 or indirectly contact with the rolling contact part 315 through another member. In the present embodiment, the bearing ball 510 may be seated on the rolling contact part 315.

Because the rolling contact part 315 has a curved portion, the nut screw body 310 can perform a rolling motion with respect to the bearing ball 520 or the outer ring part 510 on the rolling contact part 315.

The nut step part 316 protrudes further outward than the innermost region 520B of the bearing ball 520. Accordingly, the nut step part 316 is disposed to surround the innermost region 520B of the bearing ball 520. The nut bottom part 317 has the same height as the region of the rolling contact part 315, contacting the innermost region 520B of the bearing ball 520 or the outermost region 520A of the bearing ball 520.

The rolling contact part 315 includes an inner contact region 315A. The inner contact region 315A is closer to the nut step part 316 than the nut bottom part 317 with respect to the innermost region 520B of the bearing ball 520. The bearing ball 520 may be in contact with the inner surface of the rolling contact part 315 at the inner contact region 315A.

The nut screw part 300 rotates in one direction to generate braking force in the vehicle brake system, and accordingly, the bolt screw part 400 moves toward the piston part 200. In the process of generating the braking force in the vehicle brake system, the bearing ball 520 comes into contact with the inner contact region 315A of the rolling contact part 315 and the outer contact region 515A of the bearing ball contact part 515 to stably support the load of the nut screw part 300 applied in the opposite direction to the moving direction of the bolt screw part 400.

According to the present embodiment, the bearing ball 520 of the bearing part 500 may be configured as a two-point bearing that comes into contact with the inner contact region 315A of the rolling contact part 315 and the outer contact region 515A of the bearing ball contact part 515 when generating or releasing the braking force of the vehicle brake system. The two-point bearing is easier to assemble than the four-point bearing, and the ball size can be reduced, and thus the outer diameter size of the assembly of the bolt screw part 400 and the nut screw part 300 can be reduced.

During braking of the vehicle brake system, the piston part 200 may be inclined with respect to the central axis by braking torque or opening of the caliper body 100, or the cylinder 130 may be inclined with respect to the central axis. According to the present embodiment, since the bolt head 420 is capable of rolling motion with respect to the piston part 200, it is possible to prevent the load from being concentrated on only a specific ball member B among the plurality of ball members B disposed on the outer surface of the bolt screw part 400. In addition, according to the present embodiment, because the nut screw part 300 is capable of rolling motion with respect to the bearing part 500, it is possible to prevent the load from being concentrated on only a specific ball member B among the plurality of ball members B disposed on the inner surface of the nut screw part 300.

Because the vehicle brake system according to the present embodiment is capable of rolling motion in the front of the bolt screw part 400, in the outer of the nut screw part 300, or in the front of the bolt screw part 400 and the outer of the nut screw part 300, it is possible to suppress a specific ball member B from receiving the concentrated load even when the piston part 200 is inclined with respect to the central axis or the cylinder 130 is inclined with respect to the central axis. Accordingly, the vehicle brake system according to the present embodiment can improve system durability while securing robustness against inclination.

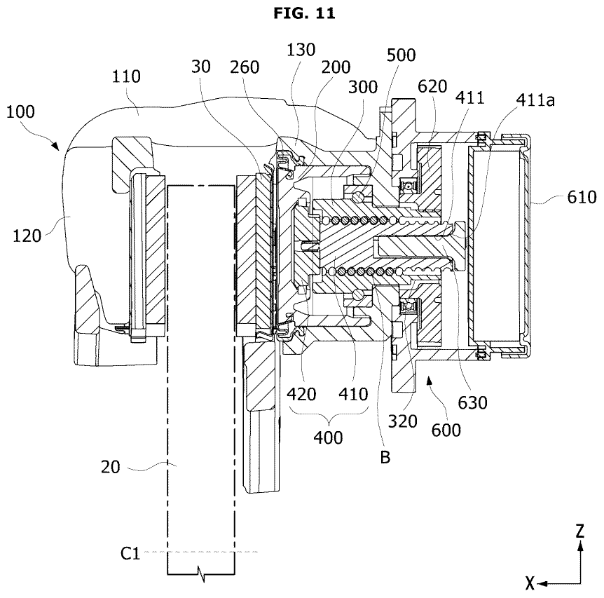

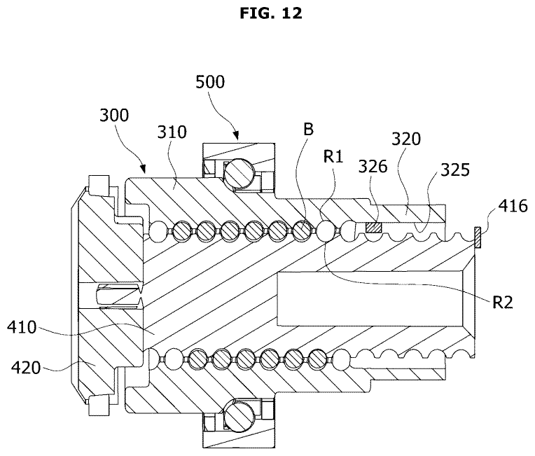

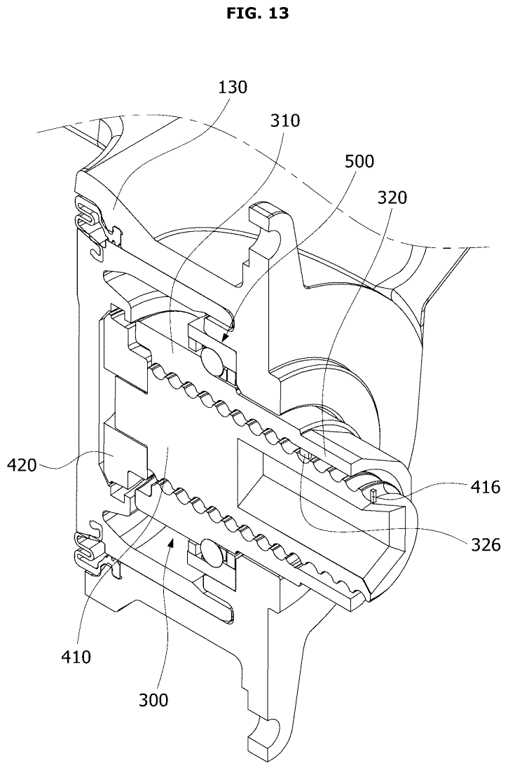

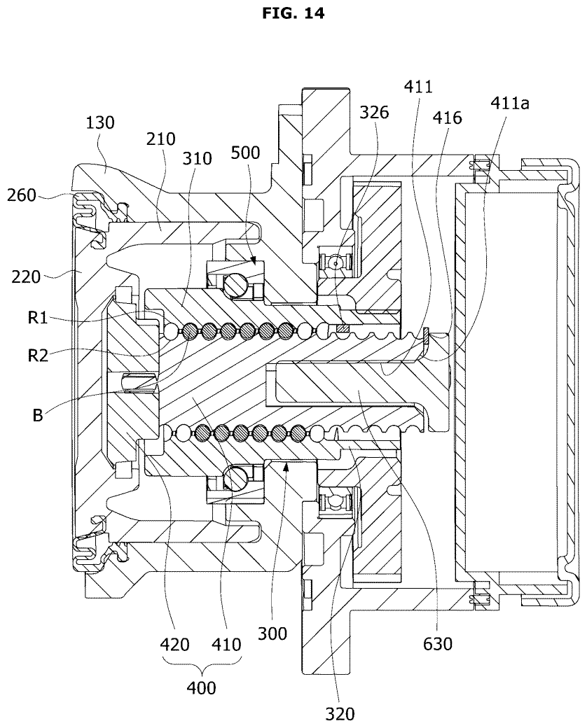

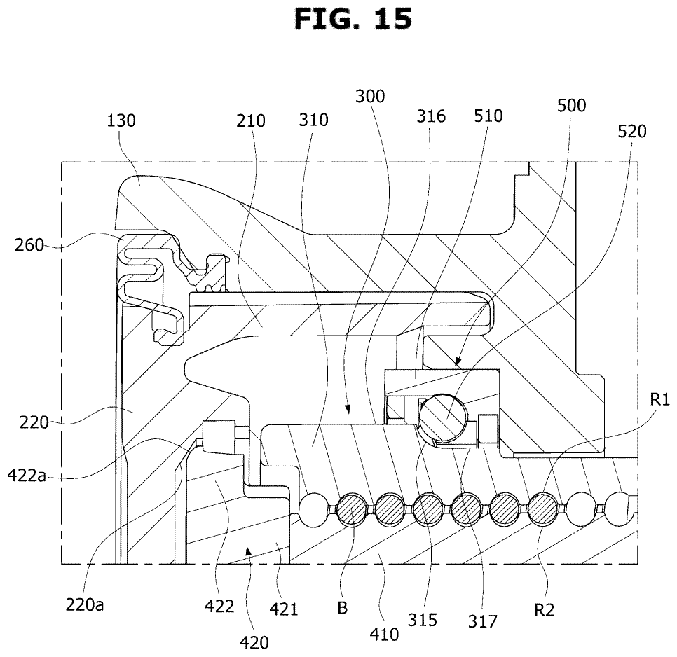

FIG. 11 is a cross-sectional view schematically illustrating a vehicle brake system according to third embodiment of the present disclosure, FIG. 12 is a cross-sectional view illustrating a nut screw part and a bolt screw part of the vehicle brake system according to the third embodiment of the present disclosure, FIG. 13 is a cross-sectional perspective view illustrating the nut screw part and the bolt screw part of the vehicle brake system according to the third embodiment of the present disclosure, FIG. 14 is a partially enlarged view of FIG. 11, and FIG. 15 is a partially enlarged view of FIG. 14.

Referring to FIG. 11 to FIG. 15 together with FIG. 1 and FIG. 6, the vehicle brake system according to the third embodiment of the present disclosure includes a caliper body 100, a piston part 200, a nut screw part 300, and a bolt screw part 400. The vehicle brake system according to the third embodiment of the present disclosure is different only in some configurations from the vehicle brake system according to the first embodiment in FIG. 1, a description of the same configurations as the vehicle brake system according to the first embodiment in FIG. 1 is omitted below.

The caliper body 100 includes a bridge 110, a finger 120, and a cylinder 130.

The piston part 200 includes a piston body 210 and a piston head 220.

The nut screw part 300 includes a nut screw body 310 and a nut screw tail 320.

A rail hole part and a through hole part 325 may be provided on an inner circumferential surface of the nut screw part 300. In the rail hole part, an outer ball rail R1 on which the ball members B are seated is disposed in a spiral shape in the longitudinal direction. The through hole part 325 is an inner circumferential surface part of the nut screw part 300 on which the outer ball rail R1 is not disposed.

The through hole part 325 is disposed along an inner circumferential surface of a nut screw tail 320. An inner diameter of the through hole part 325 is larger than the maximum outer diameter of the bolt body 410. Accordingly, the bolt body 410 may be moved in the through hole part 325 during the rotation of the nut screw part 300.

A stopper 326 is provided in the through hole part 325. The stopper 326 may be formed during processing of the inner circumferential surface of the nut screw part 300. The stopper 326 is separately disposed from the nut screw part 300, and may be press-fitted or bolted to the nut screw part 300 to be integrated with the nut screw part 300.

The stopper 326 protrudes inward from the inner circumferential surface of the through hole part 325 and is disposed on a movement path of a stopper protrusion 416. When the bolt body 410 is moved toward the piston part 200 by the rotation of the nut screw part 300, the stopper protrusion 416 provided at an end of the bolt body 410 is also moved in the same direction. Because the stopper 326 is disposed on the movement path of the stopper protrusion 416, when the bolt body 410 moves a set distance, the stopper protrusion 416 is blocked by the stopper 326 and cannot move any further. The set distance that the bolt body 410 may move may be within the maximum allowable stroke range set in the vehicle brake system.

The maximum allowable stroke of the bolt screw part 400 may be set differently depending on the thickness of a brake pad 30 required for the caliper. The bolt screw part 400 may be further moved in the first direction depending on the degree of wear of the brake pad 30, and the zero set may be reset in the further moved state.

When the bolt body 410 is moved toward the piston part 200 by a set distance, the bolt body 410 is blocked from moving toward the piston part 200 by the nut screw part 300. According to another embodiment, when the bolt screw part 400 reaches the maximum allowable stroke, the stopper protrusion 416 of the bolt screw part 400 becomes in contact with the stopper 326 of the nut screw part 300, and thus the movement of the bolt screw part 400 in the first direction is blocked.

The maximum distance that the bolt body 410 can move inside the nut screw part 300 may be the maximum allowable stroke of the bolt screw part 400. When the bolt screw part 400 is moved within the maximum allowable stroke, malfunction or failure of the vehicle brake system can be prevented in advance.

By limiting the piston stroke of the vehicle brake system as in another embodiment of the present disclosure, it is possible to prevent malfunction or failure due to various reasons including manual immaturity when the brake pad 30 is replaced due to complete wear of the brake pad 30.

The nut screw tail 320 has a non-circular column shape. The non-circular shape means a shape that is not a regular circle and encompasses shapes such as an ellipse and a polygon. In the present embodiment, the nut screw tail 320 has a polygonal column shape, specifically, an approximately hexagonal column shape.

The bolt screw part 400 includes the bolt body 410 and the bolt head 420, and the bolt head 420 includes a head connection part 421 and a head expansion part 422.

The bolt body 410 is provided with the stopper protrusion 416, specifically, at an end opposite to the bolt head 420. The stopper protrusion 416 is press-fitted or bolt-coupled to the bolt body 410 to be integrated with the bolt body 410. The stopper protrusion 416 protrudes further outward than an outer circumferential surface of the bolt body 410 to be in contact with the stopper 326 of the nut screw part 300 when the bolt body 410 is moved by a set distance. When the stopper protrusion 416 is in contact with the stopper 326, movement of the bolt body 410 in the first direction is blocked.

The bearing part 500 includes an outer ring part 510 and a bearing ball 520. The outer ring part 510 is in contact with the inner surface of the cylinder 130. The outer ring part 510 is press-fitted to the cylinder 130 to be firmly fixed in position. The bearing ball 520 is disposed between the outer ring part 510 and the nut screw body 310. In the present embodiment, the nut screw body 310 is exemplified as performing the role of the inner ring part, but the inner ring part may be formed integrally with the nut screw body 310 as in this embodiment, or may be formed separately from the nut screw body 310.

The nut screw body 310 includes a rolling contact part 315, an upper step part 316, and a lower bottom part 317.

The nut screw body 310 has an upper step part 316 disposed on the side of the piston head 220 with respect to the rolling contact part 315, and the lower bottom part 317 disposed on the side of the nut screw tail 320. The upper step part 316 protrudes outward compared to the lower bottom part 317, and the rolling contact part 315 is disposed between the upper step part 316 and the lower bottom part 317.

The rolling contact part 315 is formed as a curved portion concave toward the inside, and is disposed over the entire outer circumference of the nut screw body 310. The bearing ball 520 is in direct contact with the rolling contact part 315 or indirectly contacts the rolling contact part 315 through another member.

Because the rolling contact part 315 has a curved portion, the nut screw body 310 may perform a rolling motion with respect to the bearing ball 520 or the outer ring part 510 on the rolling contact part 315.

During braking of the vehicle brake system, the piston part 200 may be inclined with respect to the central axis by braking torque or opening of the caliper body 100, or the cylinder 130 may be inclined with respect to the central axis. According to the present embodiment, because the bolt head 420 is capable of rolling motion with respect to the piston part 200, it is possible to prevent the load from being concentrated on only a specific ball member B among the plurality of ball members B disposed on the outer surface of the bolt screw part 400. In addition, according to the present embodiment, because the nut screw part 300 is capable of rolling motion with respect to the bearing part 500, it is possible to prevent the load from being concentrated on only a specific ball member B among the plurality of ball members B disposed on the inner surface of the nut screw part 300.

Because the vehicle brake system according to the present embodiment is capable of rolling motion in the front of the bolt screw part 400, in the outer of the nut screw part 300, or in the front of the bolt screw part 400 and the outer of the nut screw part 300, it is possible to suppress a specific ball member B from receiving a concentrated load even when the piston part 200 is inclined with respect to the central axis or the cylinder 130 is inclined with respect to the central axis. Accordingly, the vehicle brake system according to the present embodiment can improve system durability while securing robustness against inclination.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A vehicle brake system comprising:
a caliper body including a cylinder;
a piston part that is movably disposed on the cylinder and disposed to face a brake pad;
a nut screw part that is disposed inside the piston part and rotates by receiving rotational force from an actuator;
a bolt screw part including a bolt body coupled to the nut screw part and receiving the rotational force from the nut screw part, and a bolt head provided separately from the bolt body, coupled to the bolt body, and disposed to face the piston part; and
a bearing part including an outer ring part in contact with an inner surface of the cylinder and a bearing ball disposed between the outer ring part and the nut screw part.

2. The vehicle brake system of claim 1, wherein the outer ring part comprises:
a bearing ball contact part on which the bearing ball is seated;
an outer ring bottom part connected to a first side of the bearing ball contact part; and
an outer ring step part connected to a second side of the bearing ball contact part and protruding further toward the nut screw part than the outer ring bottom part.

3. The vehicle brake system of claim 2, wherein the outer ring bottom part protrudes toward the nut screw part to be disposed further inside than an outermost region of the bearing ball.

4. The vehicle brake system of claim 3, wherein the nut screw part comprises:
a rolling contact part on which the bearing ball is seated;
a nut bottom part connected to a first side of the rolling contact part; and
a nut step part connected to a second side of the rolling contact part and protruding further toward the outer ring part than the nut bottom part.

5. The vehicle brake system of claim 4, wherein the nut bottom part protrudes toward the outer ring part to be disposed further outward than an innermost region of the bearing ball.

6. The vehicle brake system of claim 5,
wherein the bearing ball contact part includes a first outer contact region disposed on a side of the outer ring step part with respect to the outermost region of the bearing ball, and a second outer contact region disposed on a side of the outer ring bottom part, and
wherein the rolling contact part includes a first inner contact region disposed on a side of the nut step part with respect to the innermost region of the bearing ball, and a second inner contact region disposed on a side of the nut bottom part.

7. The vehicle brake system of claim 6, wherein the first outer contact region and the first inner contact region are disposed to face each other diagonally based on the bearing ball, and the bearing ball is supported by contacting the first outer contact region and the first inner contact region when the bolt screw part moves toward the piston part.

8. The vehicle brake system of claim 6, wherein the second outer contact region and the second inner contact region are disposed to face each other in a diagonal direction based on the bearing ball, and the bearing ball is supported by contacting the second outer contact region and the second inner contact region when the bolt screw part moves toward the opposite side of the piston part.

9. The vehicle brake system of claim 1, wherein the bolt head comprises:
a head connection part that is coupled to the bolt body and has a larger diameter than an outer diameter of the bolt body; and
a head expansion part that extends from the head connection part toward the piston part and has an outer diameter larger than the outer diameter of the head connection part.

10. The vehicle brake system of claim 9,
wherein the head expansion part has a curved surface region around an outer periphery toward the piston part, and
wherein the head expansion part is in rolling contact with the piston part on the curved surface region.

11. A vehicle brake system comprising:
a caliper body including a cylinder;
a piston part that is movably disposed on the cylinder and disposed to face a brake pad;
a nut screw part that is disposed inside the piston part, rotates by receiving rotational force from an actuator, and including an outer ball rail that forms a circulation path of ball members on an inner circumferential surface; and
a bolt screw part including a bolt body coupled with the nut screw part and receiving the rotational force from the nut screw part and a bolt head provided separately from the bolt body, coupled with the bolt body, and disposed to face the piston part, wherein an inner ball rail is provided on an outer circumferential surface of the bolt body to face the outer ball rail and forms a circulation path of the ball members,
wherein the nut screw part includes a first return hole unit through which the ball members enter and exit, a return passage communicating with the first return hole unit, and a second return hole unit communicating with the return passage and through which the ball members enter and exit.

12. The vehicle brake system of claim 11, wherein the ball members entering the first return hole unit are guided to the second return hole unit through the return passage, and the ball members entering the second return hole unit are guided to the first return hole unit through the return passage.

13. The vehicle brake system of claim 12, wherein the first return hole unit is disposed closer to the piston part than the second return hole unit.

14. The vehicle brake system of claim 13, further comprising a bearing part having an outer ring part in contact with an inner surface of the cylinder, and a bearing ball disposed between the outer ring part and the nut screw part.

15. The vehicle brake system of claim 14, wherein the outer ring part comprises:
a bearing ball contact part on which the bearing ball is seated;
an outer ring bottom part connected to a first side of the bearing ball contact part and having the same height as a region of the bearing ball contact part which contacts an outermost region of the bearing ball; and
an outer ring step part connected to a second side of the bearing ball contact part and protruding further toward the nut screw part than the outer ring bottom part.

16. A vehicle brake system comprising:
a caliper body including a cylinder;
a piston part that is movably disposed on the cylinder and disposed to face a brake pad;
a nut screw part that is disposed inside the piston part and rotates by receiving rotational force from an actuator; and
a bolt screw part including a bolt body that is coupled with the nut screw part to receive the rotational force from the nut screw part, and a bolt head that is separately provided from the bolt body to be coupled with the bolt body and disposed to face the piston part, wherein when the bolt body is moved toward the piston part by a set distance, movement toward the piston part is blocked by the nut screw part.

17. The vehicle brake system of claim 16,
wherein the bolt body is provided with a stopper protrusion, and a stopper is provided on an inner circumferential surface of the nut screw part, and
wherein when the stopper protrusion is in contact with the stopper, the bolt body is blocked from moving inside the nut screw part.

18. The vehicle brake system of claim 17, wherein the stopper protrusion protrudes further outward than an outer circumferential surface of the bolt body, and the stopper protrudes further inward than an inner circumferential surface of the nut screw part.

19. The vehicle brake system of claim 17,
wherein the stopper protrusion is press-fitted or bolted to the bolt body to be integrated, and
wherein the stopper is press-fitted or bolted to the nut screw part to be integrated.

20. The vehicle brake system of claim 16,
further comprising a bearing part that is disposed between the cylinder and the nut screw part and supports the nut screw part so that the nut screw part rotates inside the cylinder,
wherein when the piston part is inclined with respect to a central axis, the nut screw part rolls with respect to the bearing part.
